(19) United States
(12) Patent Application Publication
(10) Pub. No.: US 2007/0125895 A1
(43) Pub. Date: Jun. 7, 2007

(54) Cutter structure of a paper shredder

(75) Inventor: Kent Chen, Shanghai (CN)

Correspondence Address: WOLF, BLOCK, SCHORR & SOLIS-COHEN LLP, 1650 ARCH STREET, 22ND FLOOR, PHILADELPHIA, PA, 19103-2334, US

(73) Assignee: Aurora Office Equipment Co., Ltd.

(21) Appl. No.: 11/607,541

(22) Filed: Dec. 1, 2006

(30) Foreign Application Priority Data
Dec. 2, 2005 (CN) 200520047182.4

(51) Int. Cl. B02C 18/16

(52) U.S. Cl. 241/236; 241/295

(57) ABSTRACT

The present utility model discloses a cutter structure of a paper shredder, which comprises a pull-rod (23), paper guide combs (24), cutter arbors (21), and at least one cutter-blade set composed of two cutter-blades (22), with said cutter-blade set being slipped on said cutter arbor (21), said pull-rod (23) being passing through the hole set on said paper guide combs (24), at least two lugs (222) being set on the bore (32) of said cutter-blade (22) and extending toward a cutter spoke (35), the height of said lug (222) along axial direction of the cutter-blade (22) is greater than the thickness of said cutter blades (22); with recesses (221) being set on cylindrical cutter arbors (21), the number of which is no less than that of said lug (222) which can be placed into said recess (221); said paper guide combs (24) being set between said cutter-blade sets; said paper guide combs (24) being slipped on said cutter arbor (21). The present utility model can omit a cutter ring used in conventional cutter structure, thus reducing the components in whole cutter structure, simplifying the fixing and increasing the radial amount of feed of the cutter-blade while decreasing the cost.

### BACKGROUND OF THE INVENTION

1. Field of the Utility Model

The present utility model relates to a cutting-off equipment, in particular to a cutter structure of a paper shredder.

2. Description of the Related Art

It is well known that the actuation principle of a paper shredder used for breaking paper is to slip several cutter-blades and cutter rings which are separated each other and arranged in pairs on two rational cutter arbors, and then to drive the two parallel cutter arbors rotating in opposite direction by means of a motor and a geared system so as to cut the paper passing through it into many fine strips.

As shown in FIG. 1 to 4, a cutter structure of a paper shredder according to prior art is composed of at least one cutter-blade set, cutter arbors2l, paper guide combs 24, cutter rings 13 and pull-rods 23, and said cutter blade set is composed of two cutter-blades22. Wherein said cutter-blade sets are slipped on said cutter arbor 21 successively, said cutter rings 13 partition off said cutter-blade sets, said paper guide combs 24 are slipped on said cutter rings 13, and said pull-rods 23 are passing through the hole on said paper guide combs 24 to locate it.

Referring to FIG. 3 and FIG. 12 of a conventional cutter-blade and cutter-blade set, polygonal center hole is formed in the center of said cutter-blade for a rotational cutter arbor to pass through, and cutting-edges 30 are protruded from the periphery of cutter blade. When two cutter-blades having slipped on an rotational cutter arbor2l are merged back to back to form a cutter-blade set A, as shown, the cutting-edge of two cutter-blades forms a V-type knife-edge 33, while at the opposite rotational cutter arbor 21, a cutter ring 13 is inserted between two cutter-blades to form another cutter-blade set A' in a face to face mode. When paper to be broken is passing through two cutter arbors 21 rotating at opposite direction, the paper is cut apart by means of the relative rotation between a cutter spoke and another cutter spoke, and then the cut-off paper strips are cut down by means of the relative motion between a crooked cutting-edge 30 and the opposite cutter spoke.

In prior art, the assembling work is more tedious due to a cutter ring 13 existing in the cutter structure of a paper shredder; and the amount of broken paper is limited due to greater radial dimension of cutter ring 13, which hinders the radial feed of a cutter blade 22.

### SUMMARY OF THE UTILITY MODEL

The object of the present utility model is to provide a cutter structure of a paper shredder, which is easy to assemble, low cost and has greater amount of broken paper.

To solve above problems, the present utility model includes pull-rods, paper guide combs, cutter arbors, and at least one cutter-blade set composed of two cutter-blades. Said cutter-blade set is slipped on said cutter arbor, said pull-rod is past through the hole formed on said paper guide combs, on the bore of said cutter-blade at least two lugs are set extending toward the cutter spoke, the height of which along the axial direction of the cutter-blade is greater than the thickness of said cutter-blade; at the cylindrical cutter arbor there are several recesses, the number of which is no less than that of lugs which can be placed into said recess, said paper guide combs is put between said cutter-blade sets; and said paper guide combs are slipped on said cutter arbor.

Furthermore, said lug is a hexahedron.

In addition, said lug is perpendicular to the bore of said cutter-blade.

Furthermore, said lugs located on said cutter-blade are symmetric, and the number of said lugs is 2 or 3 pieces.

Furthermore, said lugs located on said cutter-blade are asymmetric, and the number of said lugs is 2 or 3 pieces.

Comparing with the prior art, the present utility model has following beneficial effects, which are: since there are lugs set in the bore of cutter-blade according to the present utility model, the cutter ring present in prior cutter structure is omitted, the number of assemblies in whole cutter is decreased, thus simplifying the assembling work and dropping the cost; in addition, the radial amount of feed is increased greatly due to no the cutter ring and the amount of broken paper can be increased to 5 to 6 pieces or more.

### BRIEF DESCRIPTION OF THE DRAWINGS

FIG. 1 and 2 area perspective view of a cutter structure of a paper shredder according to prior art.

FIG. 3 is a schematic view of the cutter blade in a cutter structure of a paper shredder according to prior art.

FIG. 4 is a schematic view of the cutter arbor in a cutter structure of a paper shredder according to prior art. FIG. 5 and 6 are a perspective view of the cutter structure of a paper shredder according to the present utility model.

FIG. 7 is a schematic view of a cutter-blade according to the present utility model, on whose bore two lugs are set symmetrically.

FIG. 8 is a schematic view of a cutter arbor according to the present utility model, on which 15 two recesses are set symmetrically.

FIG. 9 is a schematic view of a cutter-blade according to the present utility model, on whose bore three lugs are set symmetrically.

FIG. 10 is a schematic view of a cutter-blade according to the present utility model, on whose bore two lugs are set asymmetrically. FIG. 11 is a schematic view of a cutter arbor according to the present utility model, on which three recesses are set asymmetrically.

FIG. 12 is a schematic view of a conventional cutter structure of a paper shredder.

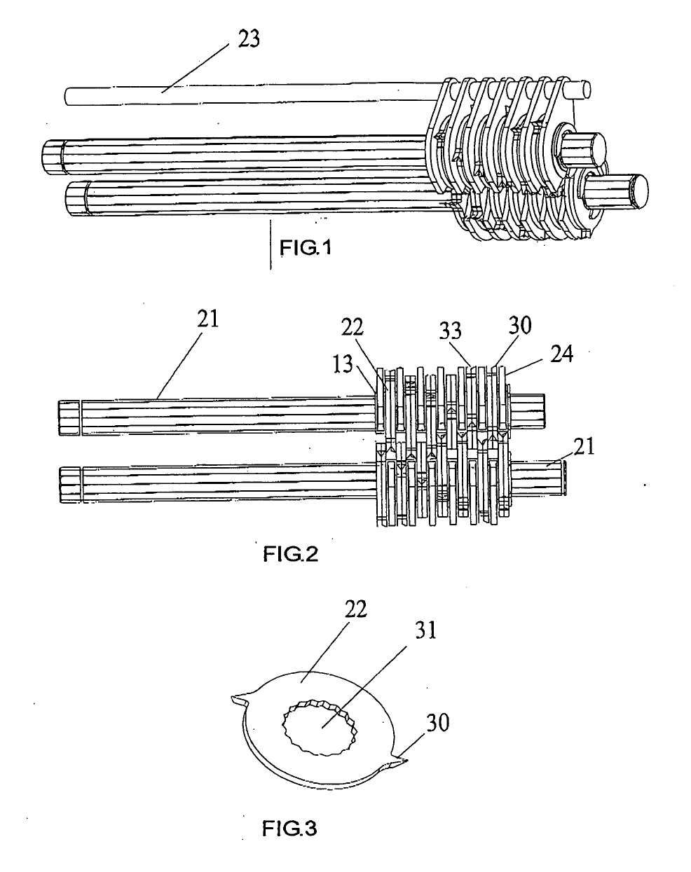

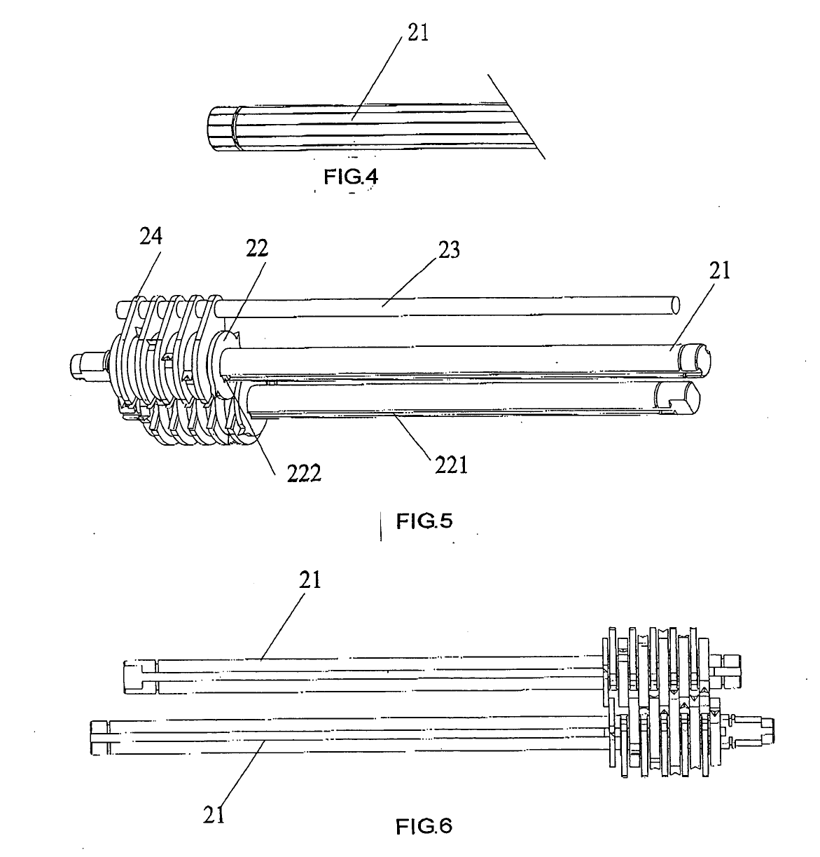

### DETAILED DESCRIPTION OF THE UTILITY MODEL

As shown in FIG. 5 and 6, the present utility model includes a pull-rod 23, a paper guide combs 24, cutter arbors 21, and at least one cutter-blade set composed of two cutter-blades 22. Said cutter-blade set is slipped on said cutter arbor 21, said pull-rod 23 is passing through the hole set on said paper guide combs 24, at least two lugs 222 extending toward the cutter spoke 35 are located on the hole of said cutter-blade 22, the height of said lugs 222 along the axial direction of said cutter-blade 22 is greater than the thickness of said cutter-blade22; on the cylindrical cutter arbor 21 there set recesses 221, the number of which is no less than that of said lug 222 which can be placed into paid recess 221; said paper guide combs 24 is inserted between paid cutter-blade sets; and said paper guide combs 24 is slipped on said 35 cutter arbor 21.

Cutter-blade sets 24 and paper guide combs 24 are slipped on a cutter arbor 21 at an alternate mode, the lugs 222 on the bore 32 of a cutter-blade 22 are put into the recesses 221 of a cutter arbor 21, so as to make the cutter-blade 22 fixing an the cutter arbor 21, and the pull-rod 23 is past through the hole of paper guide combs 24 to fix the paper guide combs 24.

The working principle of the cutter structure of a kneader according to the present utility model is as follows:

At the centre of a cutter-blade there is a round centre hole 31 for rational cutter arbor to pass through and on the periphery of a cutter-blade cutter-edges 30 are protruded. When two cutter-blade 22 passing through a rotational cutter arbor 21 are merged back to back into a cutter-blade set, i.e. the two cutter-blades take their cutter spoke opposite to the spoke 35 to merge together, the cutter-edges of two-blades will form a V-type knife-edge, and two cutter-blades on the opposite rotational cutter arbor 21 are merged back to back into another cutter-blade set, i.e. the two cutter-blades take their cutter spoke opposite to the spoke 35 to merge together; every two adjacent cutter-blade sets will be partitioned off by lugs 222 between them, and two adjacent cutter-blades which are present face to face, i.e. the two cutter-blades are merged with their cutter spoke 35, are passing through two cutter arbors 21 rotating oppositely respectively. While the paper to be broken is passing through a cutter arbor 21, the periphery of two cutter-blades are rotating oppositely, i.e. a cutter spoke and adjacent cutter spoke are rotating oppositely, so that, paper be cut off and then be cut apart through the relative motion between crooked cutter-edges 30 and their opposite cutter spoke.

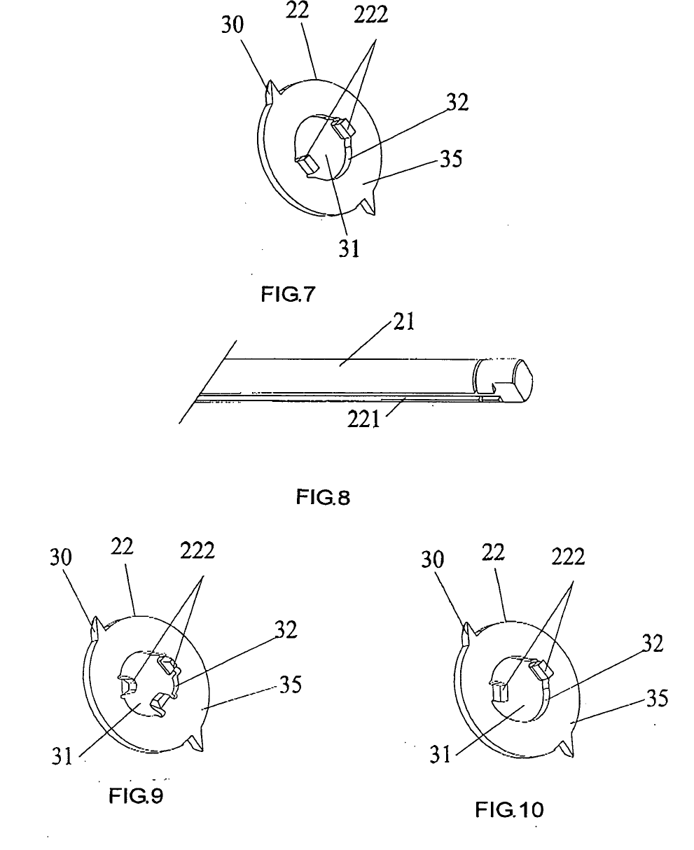

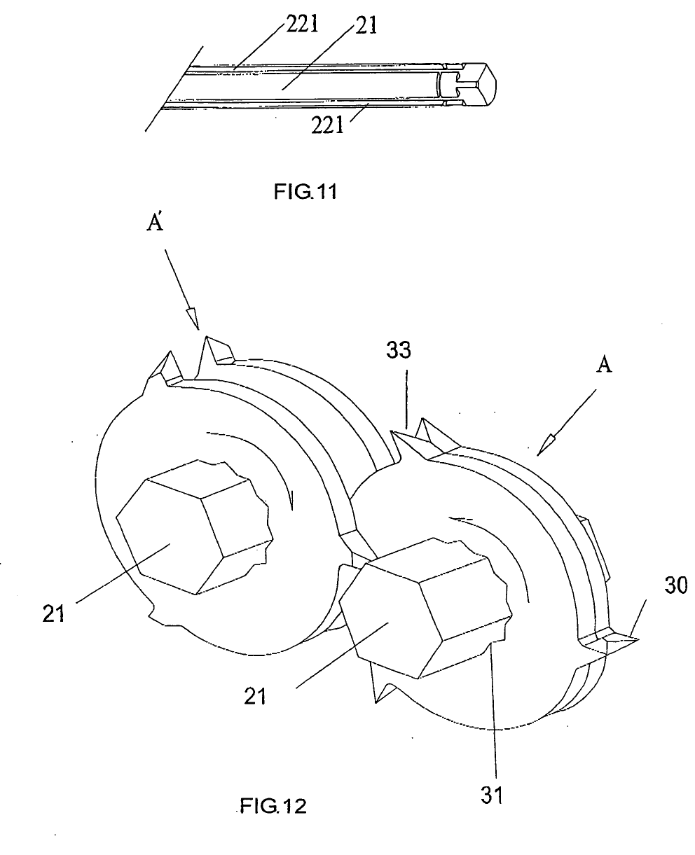

As shown, FIG. 7 and 8 are a schematic view of a cutter-blade 22 with lugs 222 and a cutter arbor 21 with recesses 221 respectively Wherein , the number of recesses 221 should not be less than that of lugs 222 , to ensure that all lugs 222 of a cutter-blade 22 can be put into corresponding recess 221.

As shown in FIG. 9 and 10, the number of lugs 222 at the bore 32 of a cutter-blade 22 may be 2, 3, 4, 5 or more. Naturally, the number of recesses 221 should also be increased in accordance with lugs 222. In addition, lugs 222 located on the bore 32 of a cutter-blade 22 may be symmetric, or asymmetric, and the location of recesses 221 should also be changed correspondingly.

Further, the shape of a lug 222 is preferably a parallelepiped, which is beneficial for partitioning off adjacent cutter-blade sets on the same cutter arbor 21. As shown in FIG. 11, it is a schematic view of a cutter arbor 21 which has three symmetric recesses 221.

1. A cutter structure of a paper shredder, which comprises pull-rods (23), paper guide combs (24), cutter arbors (21), and at least one cutter-blade set composed of two cutter-blades (22), said cutter-blade set being slipped on said cutter arbor (21), said pull-rod (23) being passed through the hole set in said paper guide combs (24), characterized in: At least two lugs (222) extending along a cutter spoke (35) are set on the bore (32) of said cutter-blade (22), the height of said lug (222) along axial direction of the cutter-blade (22) is greater than the thickness of said cutter-blade (22); on the cylindrical cutter arbor (21) some recesses (221) are set, the number of which is no less than that of said lug (222) which can be placed into said recess (221); said paper guide combs (24) is are set between both cutter-blade sets; and said paper guide combs (24) are slipped on said cutter arbor (21).

2. The cutter structure of a paper shredder according to claim 1, characterized in that said lug (222) is a hexahedron.

3. The cutter structure of a paper shredder according to claim 2, characterized in that said lug (222) is perpendicular to the bore (32) of said cutter blade (22).

4. The cutter structure of a paper shredder according to claim 3, characterized in that the position of said lugs (222) is symmetric on said cutter blade (22).

5. The cutter structure of a paper shredder according to claim 3, characterized in that the position of said lugs (222) is asymmetric on said cutter-lade (22).

6. The cutter structure of a paper shredder according to claim 4, characterized in that the number of said lug (222) is two or three.

7. The cutter structure of a paper shredder according to claim 5, characterized in that the number of said lug (222) is two or three.

8. The cutter structure of a paper shredder according to claim 1, characterized in that said lug (222) is perpendicular to the bore (32) of said cutter blade (22).
